(19) United States
(12) Patent Application Publication
(10) Pub. No.: US 2024/0178398 A1
(43) Pub. Date: May 30, 2024

(54) WATER BASED BINDER COMPOSITION AND APPLICATION THEREOF

(71) Applicant: Arkema Inc., King of Prussia, PA (US)

(72) Inventors: Ramin AMIN-SANAYEI, King of Prussia, PA (US); Jean-Marc SUAU, Lucenay (FR); Wenjun WU, King of Prussia, PA (US); Jinbao CAO, King of Prussia, PA (US); Marine DUVER, Villeurbanne (FR)

(21) Appl. No.: 18/284,901

(22) PCT Filed: May 12, 2022
(86) PCT No.: PCT/US2022/028902

§ 371 Date: Sep. 29, 2023

Related U.S. Application Data
(60) Provisional application No. 63/188,502, filed on May 14, 2021.

(51) Int. Cl. H01M 4/62; H01M 4/02; H01M 4/04; H01M 4/48

(52) U.S. Cl. CPC H01M 4/622; H01M 4/0404; H01M 4/48; H01M 2004/021; H01M 2004/027

(57) ABSTRACT

An electrode forming slurry composition is provided. The electrode-forming slurry compositions include a) from 10 to 300 parts of one or more particulate electrode-forming materials; b) from 0.1 to 60 parts of polymeric latex particles; and c) 100 parts water. The electrode forming slurry compositions can form an electrode, an anode for a non-aqueous secondary battery, in particular a lithium ion battery. The polymeric latex particles b) include i) at least one ethylenically unsaturated monomer comprising at least one acid functional group; and include ii) no fluorinated monomer or butadiene monomer polymerized therein. Also provided is an anode including the electrode forming slurry composition in dried form.

### FIELD OF THE INVENTION

The invention relates to a water-based binder composition useful in making a negative electrode of a secondary battery. The invention also relates to the negative electrode made with the binder composition as well as electrochemical storage devices using the negative electrode.

### BACKGROUND

The statements and references in this section are for background only and are not to be considered as prior art.

Secondary (rechargeable) batteries, such as lithium ion secondary batteries, are the power source for consumer electronics as well as electric vehicles. Water-based slurries are often preferred over solvent-based slurries in fabrication of the electrodes of such secondary batteries due to environmental concerns. Typically, these electrodes are manufactured by dispersing the electrode-forming ingredients in water, casting the slurry or paste on the current collector as a thin film and then allowing the film to dry to form the electrode. The function of the polymeric binder is to bind the electrode-forming particulates together onto the current collector.

A rheology modifier is typically present in the slurry formulation to adjust the slurry rheology for the electrode manufacturing casting process. Examples of rheology modifiers used in electrode formulations include but are not limited to neutralized carboxy methyl cellulose (CMC) and/or neutralized polyacrylic acid (PAA). The use of rheological modifier additives in slurries increases the raw material costs, requires extra processing steps, and takes up space in the electrode that adds to the volume and the weight of battery, which all will negatively impact battery energy density and cost. Therefore, elimination of rheology modifier additives is highly desired.

Applications of carbon nanotubes (CNTs) as the conductive additive in electrode formulations are on the rise because of their high electronic conductivity and high aspect ratio which allows forming a continuous conductive network in the active material layer of electrodes which in turn decreases electrode resistivity and polarization that is beneficial to the improvement of battery performance. Moreover, due to the superior CNTs physical resiliency, they act as mechanical reinforcement among electroactive materials in the active material layer, restraining cracking and crumbling, and thereby contributing to the integrity of the electrode as a whole. The enabling technique for achieving the full potential of CNTs in the electrode is to have a homogeneous dispersion of CNTs in slurry. Without wishing to be bound by any theory, when CNT is homogeneously dispersed in the electrode slurry, it could induce high electronic conductivity within the electrode and also resist micro-fracturing in the resultant electrodes which in turn allows to further reducing the amount of conductive carbon and binder in the electrode formulations without any compromise in the electrode performance. Furthermore, reduction in the amount of inactive ingredients will ultimately result in an increase in the electrode energy density which is advantageous for battery applications.

US Pub. 2020/0203707 discloses an electrodepositable coating composition including a binder having a pH-dependent rheology modifier that includes the residue of a crosslinking monomer and/or a monoethylenically unsaturated alkylated alkoxylate monomer; an electrochemically active material and/or an electrically conductive agent; and an aqueous medium. US Pub. 2020/203704 discloses an electrodepositable coating composition including a fluoropolymer; an electrochemically active material and/or electrically conductive agent; a pH-dependent rheology modifier; and an aqueous medium including water.

US Pub. 2013/0330622 discloses a negative electrode for a secondary battery, including a negative electrode active material, a binder, and a water-soluble polymer. The water-soluble polymer may be a copolymer containing 15 wt % to 50 wt % of an ethylenically unsaturated carboxylic acid monomer unit, 30 wt % to 70 wt % of a (meth)acrylic acid ester monomer unit, and 0.5 wt % to 10 wt % of a fluorine-containing (meth)acrylic acid ester monomer unit.

Existing styrene butadiene rubber (SBR) and acrylic rubber (ACR) binders (such as those used in US Pub. 2013/0330622) are not self-thickening because they do not contain sufficient ionizable monomers.

There are reports in the literature [K. Hays et al; J. Phys. Chem. C 2018, 122, 18, 9746-9754] that amorphous silicon (Si) can be oxidized and generate H₂ gas during aqueous slurry preparation for lithium ion battery application. The use of Si in secondary batteries is important because it may have the possibility to increase the energy density of Li ion battery anodes. However, H₂ generation imposes a safety concern, during large-scale battery fabrication.

Thus, there remains a need for water-based binder compositions for preparing the slurry of active material and conductive particles that provides suitable rheological properties, no H₂ generation, low Tg and minimum film formation temperature (MFFT), but without including additional, otherwise non-electrochemically active additives such as rheology modifiers and/or high amounts of coalescing agents that contribute to undesirable weight increase of the batteries (i.e., reduced energy density) and volatile organic compound (VOC) increase.

An objective of the invention is to provide a new composition including a polymeric binder for electrodes of a secondary electrochemical electrical energy storage device.

### SUMMARY

Surprisingly it has now been found that an electrode forming slurry composition with proper rheological properties can be achieved by using only self-thickening polymeric latex particles as a unique binder without need for additional rheological modifier additives. Thus, the present and unique binder in an electrode forming slurry composition can replace both SBR and carboxymethylcellulose (CMC) in standard slurry formulations. More surprisingly, the anode made with this electrode forming slurry composition exhibits a higher adhesion to the current collector, no H₂ generation, and lower resistivity compared to the state of the art described in the literature. The anode formed from the electrode forming slurry composition of the present invention exhibits high adhesion, high interconnectivity, and high irreversibility as a result of the water-based self-thickening binder.

The polymeric latex particles included as the unique binder in the present electrode forming slurry composition can facilitate better CNTs dispersion in the slurry, due to their novel chemical composition and self-thickening properties. The latter regulates the rheological properties of the slurry composition without the inclusion of CMC and/or polyacrylic acid (PAA), or any rheological additives, which in turn allows better dispersion of CNTs during the formulation processes.

Unexpectedly, binders of this invention prevent generation of H₂ gas during preparation of amorphous Si-containing water-borne slurries. This is an advantage for a large-scale anode production.

The invention relates to an aqueous electrode forming slurry composition, having water-based self-thickening polymeric latex particles as the binder, for manufacturing of electrodes, especially negative electrodes (anodes) for use in non-aqueous-type electrochemical devices such as batteries and also for electrodes of double layer capacitors. The aqueous electrode forming slurry composition comprises water-based self-thickening polymeric latex particles as binder, and one or more solid particulate powdery anode-forming materials. In one embodiment, the self-thickening polymeric latex particles have advantageously a Tg below 55° C. and an acid number (mg of KOH equivalent) of 40 up to 400 mg KOH where at least 10% of the acid groups of the ethylenically unsaturated monomer(s) comprising at least one acid functional group are in neutralized form. Further, the polymeric latex particles include no fluorinated monomer or butadiene monomer polymerized therein. In another embodiment, the electrode forming slurry composition is free of carboxy methyl cellulose (CMC), additional rheological modifier additives, fluorine containing binders, and/or monomers containing conjugated double bonds. In another embodiment, the pH of the self-thickening binder is between 9 and 2, and preferably between 8 and 3, and more preferably between 7 and 4. In another embodiment, the electrode forming slurry composition contains very low or no volatile organic compounds (VOC), or less than 5 parts, or less than 2 parts, or less than 1 part, or less than 0.5 parts VOCs and/or adhesion promoters and/or coalescent agents. In another embodiment, the electrode forming slurry composition is free of CMC, additional rheological modifier additives, fluorine containing binders, and/or polymers containing conjugated double bonds, the pH of the self-thickening binder is below 5, and the electrode forming slurry composition contains very low or no VOCs.

An electrode forming slurry composition is provided. The electrode-forming slurry composition includes a) from 10 to 300 parts of one or more particulate electrode-forming materials; b) from 0.1 to 60 parts of polymeric latex particles; and c) 100 parts water. The electrode forming slurry composition is capable of forming an electrode. The polymeric latex particles b) include at least one ethylenically unsaturated monomer comprising at least one acid functional group; and include no fluorinated monomer or butadiene monomer polymerized therein. The polymeric latex particles b) have the following properties:
Tg of 55° C. or less and/or a minimum film forming temperature of 25° C. or less;
volume average particle size of less than 500 nm;
pH of from 9 to 2 in one embodiment, from 8 to 3 in an embodiment, and in another embodiment from 7 to 4;
acid number of from 40 to 400 mg of KOH equivalent such that at least 10% of the acid functional groups in the ethylenically unsaturated monomer in the polymeric latex particles are neutralized; and
5% by weight of the polymeric latex particles in water have a viscosity of at least 1000 cP at a shear rate of 10 s⁻¹ and 25° C.

The electrode forming slurry composition may include the following optional components:
from 0 to 10 parts of one or more additives selected from the group consisting of anti-settling agents, surfactants, and mixtures thereof;
0 to 5 parts of one or more wetting agents;
0 to 5 parts of one or more dispersing agents;
0 to 5 parts, very low or no volatile organic compounds (VOC), or less than 5 parts, or less than 2 parts, or less than 1 part, or less than 0.5 parts of one or more VOCs, and/or adhesion promoters and/or coalescent agents; but as noted, this coalescent agent is preferably not included nor necessary due to the specific structure of the binders described in the present disclosure and
0 to 5 parts of rheology modifier additives but, again, these are preferably not included, nor are they necessary due to the specific structure of the binders described in the present disclosure.

Further areas of applicability will become apparent from the description provided herein. It should be understood that the description and specific examples are intended for purposes of illustration only and are not intended to limit the scope of the present disclosure.

### DETAILED DESCRIPTION

The purpose of the binder is to provide adhesion and cohesion in a matrix for the particulate electrode-forming materials, which typically include an active material (a material capable of accepting the lithium ions) and a conductive material. The disclosed polymeric latex particles as the binder contain a relatively high percentage of acid functional groups. The disclosed polymeric latex particles as binder may also contain other monomers.

The composition for use as an electrode as disclosed herein is typically prepared as a slurry, although it may be in the form of a solution, a dispersion, or a paste. Forming the electrode may therefore be done by applying a layer of the electrode forming slurry composition to the current collector. The conductive electrode forming slurry composition layer is then dried, to form the layer of electrode material adhered to the current collector.

As used herein, the term “electrode” refers to the dried layer of the electrode-forming slurry composition that is cast onto the current collector. Typically, electrodes are manufactured by casting the slurry or paste of dispersed electrode-forming ingredients and binder(s) as a thin film and then allowing the film to dry to form an electrode. This dried film is referred to as the electrode,

As used herein, the term “electrode assembly” is the combination of the current collector and the dried electrode that is dried thereon. The slurry or paste of dispersed electrode-forming ingredients and binder(s) can be cast onto current collector such as a copper or nickel foil to form the electrode assembly. The electrode assembly can be further coated with a separator forming slurry such as alumina and binder dispersed in water. The separator slurry can be cast simultaneously with the electrode slurry in a one-step process using a dual or a multi-die in a wet-on-wet process. Alternatively, after the electrode is dried, the separator slurry may be cast onto the electrode, or a free standing separator can be adhered onto the electrode surface. The electrode assembly therefore includes the current collector, the dried electrode film, and optionally a separator film on the top surface of the electrode.

The function of the polymeric binder is to bind the electrode-forming particulates together onto the current collector and to provide mechanical properties during battery use.

The composition for use as an electrode can be deposited by any method known in the art. Non-limiting examples of such application methods include spraying, rolling, drawdown bar application, bird bar application, gravure, slot coating, or other coil coating methods. The composition is dried, optionally with heat to remove water and any other volatile materials. The coating of the composition may be optionally calendered after the drying step to reduce its porosity. The drying times, temperatures, and any vacuum used can be adjusted to achieve the desired drying.

The current collector may be in the structural form of a mesh, a foam, a foil, a rod, or another morphology that does not interfere with current collector function. Current collector materials vary depending on whether an electrode is a positive electrode (cathode) or a negative electrode (anode). The most common current collectors for a negative electrode are sheets or foils of copper (Cu⁰) or nickel (Ni⁰) metal. The electrode material for the anode is applied to and must adhere to the surface of the current collector to form the anode assembly.

As used herein, the term “slurry” means a free-flowing or flowable and/or pumpable suspension including fine solid materials and binder in water. Such fine solids may include, inter alia, polymeric binder particles, in addition to the solid particles that are usually the electrochemically active material(s) and conductive materials(s) necessary to form the electrode for a secondary battery. Additives may also be dissolved in the water.

As discussed above, an electrode forming slurry composition is provided. The electrode forming slurry includes a) from 10 to 300 parts of one or more particulate electrode-forming materials; b) from 0.1 to 60 parts of polymeric latex particles; and c) 100 parts water. The electrode forming slurry composition is capable of forming an electrode. The polymeric latex particles b) include i) at least one ethylenically unsaturated monomer comprising at least one acid functional group; and include ii) no fluorinated monomer or butadiene monomer polymerized therein.

The polymeric latex particles b) have the following properties:
Tg of 55° C. or less and/or a minimum film forming temperature of 25° C. or less;
volume average particle size of less than 500 nm;
in an embodiment, a pH of from 9 to 2, in another embodiment from 8 to 3, and in another embodiment from 7 to 4;
acid number of from 40 to 400 mg of KOH equivalent such that at least 10% of the acid functional groups from the i) at least one ethylenically unsaturated monomer comprising at least one acid functional group in the polymeric latex particles b) are neutralized; and
5% by weight of the polymeric latex particles in water have a viscosity of at least 1000 cP at a shear rate of 10 s⁻¹ and 25° C.

The electrode forming slurry composition may include the following optional components:
d) 0 to 5 parts of one or more wetting agents;
e) 0 to 5 parts of one or more dispersing agents;
f) 0 to 5 parts of one or more VOCs, very low or no volatile organic compounds (VOC), or less than 5 parts, or less than 2 parts, or less than 1 part, or less than 0.5 parts VOCs, and/or adhesion promoters and/or coalescent agents;
g) 0 to 5 parts of rheology modifier additives; and
h) from 0 to 10 parts of one or more additives selected from the group consisting of anti-settling agents, surfactants, and mixtures thereof.

The electrode film of a lithium ion battery and/or lithium ion capacitor may comprise a) particulate or powdery anode-forming materials and b) polymeric latex particles that are the binder material.

Advantageously, the present electrode forming slurry composition preferably does not include carboxy methyl cellulose (CMC) and/or fluorine-containing binders, such as polyvinylidene fluoride (PVDF), polytetrafluoroethylene (PTFE) polyethylene chlorotrifluoroethylene (ECTFE) polyethylene tetrafluoroethylene (ETFE), fluorinated-ethylene-propylene (FEP), perfluoro-alkoxy (PFA), polychlorotrifluoroethylene (PCTFE), fluoroacrylates, or fluorosilicones. Fluorine-containing polymers are relatively very expensive, and generally exhibit low surface energy or low adhesion which in turn diminishes binder efficacy. The present electrode forming composition also preferably does not include conjugated double bond-containing polymers, such as those containing butadiene, isoprene, and/or chloroprene as a monomer or co-monomer. Polymers that contain conjugated double bonds are susceptible to oxidation, which in turn reduces longevity and usefulness of the polymer. The present electrode forming composition preferably does not contain any rheological additives except the self-thickening binder of the present disclosure.

Particulate Anode-Forming Materials a)

The electrode forming slurry composition disclosed herein includes from 10 to 500 parts of one or more particulate anode-forming materials, based on 100 parts of water. In an embodiment, the electrode forming slurry may include from 20 to 400 parts of the one or more particulate anode-forming materials per 100 parts of water. In an embodiment, the electrode forming slurry may include from 30 to 300 parts of the one or more particulate anode-forming materials per 100 parts of water. In an embodiment, the electrode forming slurry may include from 50 to 200 parts of the one or more particulate anode-forming materials per 100 parts of water.

The particulate anode-forming materials may include but are not limited to a conductive carbon additive, carbon nanotubes (CNTs), synthetic graphite, natural graphite, hard carbon, activated carbon, carbon black, graphene, mesoporous carbon, amorphous silicon, semi-crystalline silicon, silicon oxides, silicon nanowires, tin, tin oxides, germanium, lithium titanate, mixtures or composites of the aforementioned materials, and/or other materials known in the art or described herein as suitable for use as the anode in a lithium ion battery. These particulates may include active materials, i.e., materials capable of intercalating (accepting) lithium ions, and conductive materials. The electrode film of a lithium ion capacitor and/or a lithium ion battery can include about 80 weight percent, preferably up to 94, and more preferably up to 98 weight percent of the particulate anode-forming materials, after drying. These anode forming materials are typically in the form of solid powders.

Conductive carbon materials such as carbon black and graphite powders are widely used in positive and negative electrodes to decrease the inner electrical resistance of an electrochemical system. Non-limiting examples of conductive carbon may include furnace black, acetylene black, CNT, fine graphite powder, vapor deposited graphite fibers, and Ketjen carbon black. The typical loading level of the conductive carbon relative to the active material in the electrode forming materials a) is usually within the range of 0.1% by weight to 20% by weight, and more preferably within the range of 0.5% by weight to 10% by weight of the total amount of the particulate anode-forming materials.

The amount of the particulate anode-forming materials (including both the active material and the conductive carbon) a) present in the electrode forming slurry composition, may be from 50 wt % to 99 wt % of the total dried weight of the composition, preferably from 80 wt % to 98 wt % and most preferably from 94 wt % to 98 wt % of the total dried weight of the composition.

Polymeric Latex Particles b)

The electrode forming slurry composition further includes polymeric latex particles b) as a binder. The binder is present in the electrode, and one primary function of the binder is to bind together the active materials, and conductive material, as well as to contribute to adhering the electrode to the current collector.

The polymeric latex particles b) are present in the electrode forming slurry composition at from 0.1 to 20 parts per hundred parts of the c) water in the electrode forming slurry composition. In an embodiment, the polymeric latex particles b) are present in the electrode forming slurry composition at from 0.5 to 20 parts, in another embodiment at from 1 to 15, and in another embodiment from 2 to 10 parts per hundred parts c) water in the electrode forming slurry composition.

The present inventors surprisingly found that the Tg of the disclosed polymeric latex particles b) binder should be within a desired range to balance the polymeric latex particles b) binder's mechanical properties. The Tg is the temperature below which the physical properties of plastics change from thermoplastic (e.g. flexible, soft, stretchable) to those of the glassy state which limits flexibility and elongation of the polymeric latex particles b) binder. As a result, upon bending of electrode, cracks (visible or micro-cracks) can form in electrodes which in turn deteriorate electrode performance. At above Tg, the polymeric latex particles b) binder behaves like a rubbery material which can accommodate flexibility and elongation.

Therefore, the properties of the polymeric latex particles b) binder can be dramatically different above and below its Tg. For ease of electrode handling and good electrode performance, the Tg of the polymeric latex particles b) may be close to or preferably below room temperature, i.e. below 55° C., below 45, ° C., below 35° C., below 25° C., below 20° C., or below 10° C., according to certain embodiments.

Without limiting the scope of the invention and without intending to be bound to any theory, in order to have a satisfactory electrode integrity using the electrode forming slurry composition disclosed herein, as the aqueous phase evaporates, the polymeric latex particles b) that comprise the binder particles coalesce into a continuous network which can hold the active materials and conductive carbon in an interconnected electrode network. The minimum film formation temperature (MFFT) of the polymeric latex particles b) binder is the minimum temperature where the coalescence of the polymeric particles occurs as the water evaporates to form continuous films. The MFFT is the minimum temperature at which the polymer latex particles b) coalesce to form a continuous film. The polymeric latex particles b) binder advantageously have an MFFT near or below room temperature, i.e., below 55° C., below 50° C., below 45° C., below 35° C., below 25° C., or below 20° C., according to certain embodiments. Suitable Tg helps with electrode processing and handling.

Because of the desirable Tg of the polymeric latex particles b), there is little or no need for adding coalescents that contribute to the volatile organic content (VOC) of the electrode forming slurry composition of this invention. In an embodiment, the electrode forming composition has a VOC content of from 0 to less than 5 wt %, in another embodiment from 0 to less than 1 wt %, and in still another embodiment from 0 to less than 0.1 wt %.

Thermal analysis using Differential Scanning Calorimetry (DSC) can provide a convenient method to measure the glass transition temperature (Tg) of the polymeric latex particles b) as binder after drying. The measurements are performed in accordance with ATSM-D3418-15 (2018) using a standard heating rate of 10° C./min. The reported measured glass transition temperatures in this disclosure are measured during the second heating cycle unless noted otherwise. Estimated glass transition temperatures reported herein are calculated using the Fox equation.

The polymeric latex particles b) include as polymerized monomers:
i) at least one ethylenically unsaturated monomer comprising at least one acid functional group; and
ii) no fluorinated monomer or monomer containing conjugated double bonds polymerized therein. Non-limiting examples of such monomers that are not included in certain embodiments include, butadiene, isoprene, vinyl fluoride, tetrafluoroethylene, vinylidene fluoride, chlorotrifluoroethylene, hexafluoropropylene, perfluoroprulyvinylether, perfluoromethylvinyl ether, fluoro acrylate monomers, and mixtures thereof.

In an embodiment, the polymeric latex particles b) may have a volume average particle size less than 500 nm, in another embodiment less than 250 nm and in another embodiment, less than 150 nm.

Ethylenically Unsaturated Monomer Including at Least One Acid Functional Group i)

Regarding the at least one ethylenically unsaturated monomer including at least one acid functional group i), it has been found in particular, that carboxylic acid functional group-containing monomers included as the monomer i) in the polymeric latex particles b) can be used in the polymeric latex particles that form the binder for the anode with significant advantageous effects. Other suitable acid groups in addition to the carboxylic acid groups that may be included in the at least one ethylenically unsaturated monomer comprising at least one acid functional group are sulfonic and sulfuric acid groups or phosphonic and phosphoric acid groups.

Non-limiting examples of suitable ethylenically unsaturated monomers including at least one acid functional group i) include but are not limited to (meth) acrylic acid, beta-carboxyethyl acrylate, 4 styrene sulfonic acid, 2-acrylamido-2-methylpropane sulfonic acid, and mono-ester of itaconic, maleic acid, fumaric acid, and mixtures thereof.

For example, from 10% to 60% by weight of the total polymerized monomers in the polymeric latex particles b) may be the i) at least one ethylenically unsaturated monomer comprising at least one acid functional group. In an embodiment, the polymeric latex particles include from 20% to 55%, in another embodiment from 25% to 45%, and in still another embodiment from 30% to 55% by weight of the total polymerized monomers in the polymeric latex particles b) may be the at least one ethylenically unsaturated monomer comprising at least one acid functional group i).

In contrast to certain of the above-cited references, the self-thickening polymeric latex particles b) that function as the binder in the electrode-forming slurry composition are partially neutralized prior to, or in the first step of making the electrode forming composition by adding base such as ammonia solution, lithium hydroxide, sodium hydroxide, potassium hydroxide to the aqueous polymeric latex particles b) (binder) in order to arrive at the proper slurry viscosity.

These polymeric latex particles b) are self-thickening because under acidic conditions, the self-thickening polymeric latex particles b) used as the binder in the electrode forming composition are in the form of an emulsion with a very low viscosity of less than 200 cP before being neutralized by a base. Without intending to be bound by any theory, when the self-thickening binder is partially or totally neutralized with a base, such as an ammonia solution or a lithium hydroxide solution, it exhibits a self-thickening mechanism due to, for example, an increase in hydrodynamic volume of the emulsion of polymeric latex particles b).

In particular, the polymeric latex particles a) have an acid number of from 40 to 400 mg of KOH equivalent such that at least 10% of the acid functional groups of the at least one ethylenically unsaturated monomer comprising at least one acid functional group i) are neutralized. In an embodiment, the acid number is from 50 to 350, in another embodiment from 75 to 325 and in still another embodiment from 100 to 300 mg of KOH equivalent. Thus, preferably at least 10%, more preferably at least 20% and most preferably at least 30% of the acid groups of the at least one ethylenically unsaturated monomer comprising at least one acid functional group i) are neutralized. Accordingly, a sufficient amount of a base may be added to the electrode forming slurry composition such that the pH of the electrode-forming slurry composition is from 9 to 2, preferably from 8 to 3, more preferably from 7 to 3, most preferably from 7 to 4. Suitable bases include, but are not limited to lithium hydroxide, ammonia (ammonium hydroxide), potassium hydroxide, sodium hydroxide, triethyl amine, N.N-dimethyl ethanol amine, n-morpholine, or n-methyl morpholine. Lithium hydroxide is most preferred.

Accordingly, the polymeric latex particles b) are self-thickening such that when the pH of the emulsion is equal to or less than, an emulsion consisting of 5 wt % of the polymeric latex particles in water has a viscosity of less than 100 cP at shear rate of 10 s⁻¹ and 25° C., and upon addition of a base such that the pH of the emulsion is 4 or higher, the viscosity of the emulsion increases at least by 10 fold or to at least 1000 cP at shear rate of 10 s⁻¹ and 25° C. According to an embodiment, 5 wt % of the polymeric latex particles b) in water have a viscosity of at least 2000 cP at a shear rate of 10 s⁻¹ and 25° C. after addition of the base such that the pH of the emulsion of polymeric latex particles b) in water is 7 or less than 7, or 6 or less than 6, or 5 or less than 5.

Co-Monomers in the Polymeric Latex Particles b)

In order to achieve a good balance between binder properties and the self-thickening attributes, the polymeric latex particle binder may be a copolymer typically prepared from the monomers containing an acid group i), discussed above, and other co-monomers.

Non-Ionic Ethylenically Unsaturated Monomers ii)

For example, certain hydrophobic groups may be included in the polymeric particles b) which, upon drying will act as a robust three-dimensional binder to form the electrode. Such hydrophobic groups are from co-monomers that may also be present in the polymeric latex particles b) as polymerized monomers, in addition to the at least one ethylenically unsaturated monomer comprising at least one acid functional group i).

Suitable such non-ionic ethylenically unsaturated monomers ii) may be a non-water soluble lower alkyl ester of (meth)acrylic or other acids) and/or an associative monomer containing hydrophobic groups, such as hydrophobically modified polyoxyalkylene ester(s) and monomers containing non-ionic groups. Suitable non-ionic ethylenically unsaturated monomers ii) include but are not limited to acrylic and methacrylic acid esters, such as C1 to C12 (meth)acrylates, (meth)acrylamides, (meth)acrylonitriles, vinyl acetate, styrene and derivatives thereof, diisobutylene, vinylpyrrolidone, vinylcaprolactam, and mixtures thereof.

The polymeric latex particles b) may include, as polymerized monomers, from 40 to 90%, by weight of the total polymerized monomers, of at the least one non-ionic ethylenically unsaturated monomer ii). The polymeric latex particles b) include, as polymerized monomers, preferably from 45% to 85%, more preferably from 50% to 80%, most preferably from 50% to 75% by weight of the total polymerized monomers, of at the least one non-ionic ethylenically unsaturated monomer ii).

Crosslinkable Monomers iii):

In order to restrain the self-thickening polymeric latex particles b) from infinite expansion, optional cross-linkers may be incorporated into the polymeric latex particles b) such that they may form soft microgels.

The polymeric latex particles b) (binder) can be optionally cross-linked by using crosslinking monomers that contain at least two free radical polymerizable ethylenically unsaturated moieties. In one embodiment, crosslinkers employed in this invention typically are polyvinyl aromatic monomers (divinylbenzene, and diallyl phthalate); polyalkenyl ethers (triallyl pentaerythritol, diallyl pentaerythritol, diallyl sucrose, octaallyl sucrose, and trimethylolpropane diallyl ether); polyunsaturated esters of polyalcohols or polyacids (trimethylolpropane tri(meth)acrylate, trimethylolpropane, polyethyleneglycol di(meth)acrylates). In another embodiment, these crosslinkable monomers iii) are pentaerythritol, sorbitol, or sucrose; diacrylic or dimethacrylic esters derived from polyols selected from pentaerythritol, sorbitol, or sucrose; divinyl naphthalene, trivinylbenzene, 1,2,4-trivinylcyclohexane, triallyl pentaerythritol, diallyl pentaerythritol, diallyl sucrose, trimethylolpropane diallyl ether, 1,6-hexanediol di(meth)acrylate, allyl (meth)acrylate, diallyl itaconate, diallyl fumarate, diallyl maleate, butanediol dimethacrylate, ethylene di(meth)acrylate, poly(ethylene glycol) di(meth)acrylate, trimethylolpropane tri(meth)acrylate, methylenebis(meth)acrylamide, triallylcyanurates, diallyl phthalate, divinylbenzene and mixtures thereof. According to another embodiment, these cross-linkers may be selected from DAP: diallyl phthalate; EGDMA: ethylene glycol dimethacrylate; MBA: methylene bis acrylamide; DVB: divinylbenzene; FRA: bicyclopentenyloxyethyl-methacrylate APE: trimethylol propane triallyl ether; and combinations thereof.

The crosslinkable monomers iii) may be present in the polymeric latex particles b) at from 0.05% to 5%, by weight of total polymerized monomers in the polymeric latex particles b). In an embodiment, the crosslinkable monomers iii) are present at from 0.01% to 4%, in another embodiment at from 0.1 to 3%, and in another embodiment at from 0.1% to 2% by weight of total polymerized monomers in the polymeric latex particles b).

Oxyalkylated Monomer with Ethylenic Unsaturation and Terminated by a Hydrogen or Hydrophobic Aryl or Alkyl Chain with 1 to 60 Carbon Atoms iv)

The disclosed polymeric binder b) may further contain an oxyalkylated monomer or monomers with ethylenic unsaturation and terminated by a hydrophobic aryl or alkyl chain with 10 to 60 carbon atoms iv), having the following formula:

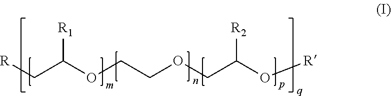

wherein:
m and p represent a number of alkylene oxide units of between 0 and 150,
n represents a number of ethylene oxide units of between 5 and 150,
q represents a whole number at least equal to 1 and such that 5≤(m+n+p)q≤150, and preferentially such that 15≤(m+n+p)q≤120,
R₁ represents the methyl or ethyl group,
R₂ represents the methyl or ethyl group,
R represents a polymerizable unsaturated function belonging to the group of acrylic, methacrylic, maleic, itaconic, crotonic esters; and
R′ represents a hydrophobic aryl or alkyl chain with 10 to 60 carbon atoms.

The hydrophobic aryl or alkyl chain in this monomer iv) may impart additional interaction between the polymeric latex polymer b) and the anode-forming materials a) to improve dispersability. It also may improve the rheology tuning property of the electrode forming composition upon neutralization. In an embodiment, the weight percentage of the oxyalkylated monomer iv) in the disclosed polymeric binder b) is preferably within the range of 0.1% to 15% by weight, in another embodiment within the range of 1% to 10% by weight, and in another embodiment within the range of 2% to 7% by weight of the monomers in the polymeric latex particles b).

According to an embodiment, q represents a whole number at least equal to 1 and such that 15≤(m+n+p)q≤120.

According to an embodiment, R represents a group selected from the group consisting of acrylate, methacrylate, acrylurethane, methacrylurethane, vinyl, allyl, methallyl, isoprenyl, an unsaturated urethane group, and combinations thereof. According to another embodiment, R represents a group selected from the group consisting of acrylurethane, methacrylurethane, α-α′-dimethyl-isopropenyl-benzylurethane, allylurethane, and combinations thereof. According to an embodiment, R represents a group selected from the group consisting of acrylate, methacrylate, acrylurethane, methacrylurethane, vinyl, allyl, methallyl and isoprenyl, esters of maleic acid, esters of itaconic acid, esters of crotonic acid, and combinations thereof. According to an embodiment, R represents a methacrylate group.

Optional components in the electrode forming slurry composition:
d) optionally from 0 to 5 parts of one or more wetting agents;
e) optionally from 0 to 5 parts of one or more dispersing agents;
f) optionally from 0 to 5 parts of one or more VOCs, very low or no volatile organic compounds (VOC), or less than 5 parts, or less than 2 parts, or less than 1 part, or less than 0.5 parts VOCs and/or adhesion promoters and/or coalescent agents;
g) optionally from 0 to 5 parts of rheology modifier additives; and
h) optionally from 0 to 10 parts of one or more additives selected from the group consisting of anti-settling agents, surfactants, and mixtures thereof.

Applications:

The electrode forming composition may be used as the active layer on an anode for use within an electrical energy storage device. Also disclosed is an anode is made from a current collector coated on at least one surface with the electrode forming slurry composition disclosed herein in dried form, such that the anode has a thickness of at least 10 microns and exhibits resistivity less than 100 Ω·cm in the z-direction. The resistivity is measured as described in the examples.

The anode maybe used in an electrical energy storage device containing a non-aqueous electrolyte, the electrical energy storage device comprising at least one anode is made from a current collector coated on at least one surface with the electrode forming slurry composition disclosed herein in dried form. The electrical energy storage device is selected from the group consisting of a non-aqueous-type battery, a capacitor, and a membrane electrode assembly.

### EXAMPLES

### a—Synthesis

### Example 1: Production of Binder

Into a 1 L reactor was introduced an initial charge composed of 413 g of deionized water and 3.1 g of sodium dodecyl sulfate. 113 g of methacrylic acid, 204 g of butyl acrylate and 0.525 g of diallyl phthalate were weighed out in a first glass beaker and mixed with 1 g of sodium dodecyl sulfate and 145 g of deionized water. 0. 70 g of ammonium persulfate was weighed in a second glass beaker, dissolved in 10 g of deionized water. 0.07 g of sodium bisulfite was weighed in a third glass beaker, dissolved in 40 g of deionized water.

The contents of the reactor were heated to a temperature of 76±2° C. The two solutions of persulfate and bisulfite were introduced in one shot in the reactor. During two hours, the monomers from the first beaker were introduced into the polymerization reactor at a temperature of 76±2° C. Then, 0.106 g of ammonium persulfate dissolved in 20 g of deionized water was introduced into the reactor over 1 hour. Then, it was cooked for 1 hour before allowing the medium to cool and then to filter it. The composition of copolymer is detailed in Table 1.

### Example 2: Production of Binder

The binder was produced in a similar manner as compared to Example 1 except that monomers selection and ratio were different. The weight percentage of each monomer to total monomer used is listed in Table 1.

### Example 3: Production of Binder

The binder was produced in a similar manner as compared to Example 1 except that monomers selection and ratio were different. The weight percentage of each monomer to total monomer used is listed in Table 1.

### Example 4: Production of Binder

The binder was produced in a similar manner as compared to Example 1 except that monomers selection and ratio were different. The weight percentage of each monomer to total monomer used is listed in Table 1.

### Example 5: Production of Binder

The binder was produced in a similar manner as compared to Example 1 except that monomers selection and ratio were different. The weight percentage of each monomer to total monomer used is listed in Table 1.

### Example 6: Production of Binder

The binder was produced in a similar manner as compared to Example 1 except that monomers selection and ratio were different. The weight percentage of each monomer to total monomer used is listed in Table 1.

### Example 7: Production of Binder

The binder was produced in a similar manner as compared to Example 1 except that monomers selection and ratio were different. The weight percentage of each monomer to total monomer used is listed in Table 1

### Example 8: Production of Binder

The binder was produced in a similar manner as compared to Example 1 except that monomers selection and ratio were different. The weight percentage of each monomer to total monomer used is listed in Table 1.

### Example 9: Production of Binder

The binder was produced in a similar manner as compared to Example 1 except that monomers selection and ratio were different. The weight percentage of each monomer to total monomer used is listed in Table 1.

### b—Slurry Formulation of Comparative Examples

In the 125 mL polyethylene container of Thinky ARE-310, was placed seven 6.5 mm zirconia balls.

0.176 gr of carbon black (Super P-Li from Timcal) plus 2.0 g of carboxymethyl cellulose (CMC) solution (7H3SF from Ashland Chemicals) at 2% solids in water and 7.92 g of graphite MCP 1 5 μm were added and mixed at 2000 rpm for 2 minutes. Then, 3.0 g of CMC solution was successively added and mixed at 2000 rpm for 2 minutes, followed by another CMC solution addition and mixing to reach 8.8 total CMC solution addition. Then 1.76 g of styrene butadiene rubber (SBR) latex at 30% solids (from Zeon) was added and mixed for 2 minutes at 2000 rpm for two times.

The slurry exhibited a smooth creamy characteristics and had about 47% solids with viscosity of 4000 cP at 10 l/s measured with Brookfield V-III, and pH 4 to 7.

### c—Slurry Formulation of Examples

A 3 g of latex of 30% solids, is diluted with 14 g of water, then 4.5 to 6 g of ammonia 0.5% solution is added to prepare water-based self-thickening acrylic binder. The finial dispersion contains 4% solids and exhibiting self-thickening effect.

In the 125 mL polyethylene container of Thinky ARE-310, was placed seven 6.5 mm zirconia balls. 0.176 gr of carbon black (Super P-Li from Timcal) plus 2.0 g of self-thickened latex and 7.92 g of graphite MCP 15 um were added and mixed at 2000 rpm for 2 minutes. Then, 3.0 g of self-thickened latex was successively added and mixed at 2000 rpm for 2 minutes, followed by another self-thickened latex addition and mixing to reach 9.973 total self-thickened latex addition. The slurry exhibits a smooth creamy characteristics and had about 47% solids with viscosity of 4000 cP at 10 l/s measured with Brookfield V-III.

### d—Electrode Fabrication & Testing

The slurries were cast on to copper foil with a wet thickness of about 110 μm and placed in to a convection oven for 30 min at 120° C. Then, the electrode was calendered to reach porosity of about 30% by volume. Then a sample having 1.33 cm² surface area was made by stamp cutting of the cast composite. The thickness of sample was measured with micrometer having accuracy of 0.1 micron. The Instron machine was used with three 0.09 cm² gold plated electrodes to determine resistivity. Circular Au-coated contacts were adhered to fixture/chucks of Instron using 3M double-sided tape. Resistance was measured using Yokogawa digital resistance meter (755601, 4 probe). Contact pressure is applied using Instron (SOON load cell) at rate of 20 N/min. All data was recorded manually at different loads. Resistivity, p is defined below:

$$ρ = \frac{RA}{{δ}_{eff}} = Ω \cdot cm ;$$

where A is the apparent contact area, cm²; R is the measured resistance, ohm (Ω); and δ_{eff} is the effective thickness, cm.

Mass loading was measured by punching several ½ inch circular samples out of dried electrode supported on copper foil and weighing them with 5 decimal point balance.

Electrodes were calendared at very high pressure at room temperature to arrive at desired porosity. Porosity of the electrodes were back calculated from its expected (weight contribution of each component) and apparent densities where the apparent densities was obtained by measuring weight and volume of the electrode using micrometer and 5 decimal point balance.

Estimated Tgs are calculated using the Fox equation.

The MFFT was determined in accordance with the ASTM-D2354-10 (2018) entitled “Standard Test Method for Minimum Film Formation Temperature (MFFT) of Emulsion Vehicles” to ensure the fluidity and malleability of the resin particle and thereby their ability to coalesce. MFFT data is shown in Tables 1 and 2. (more supporting MFFT data will be generated)

Adhesion measurements were performed with an Instron using 180 degree peel at 50 mm/min crosshead speed using 1 in wide electrode specimens according to ASTM-D903 (2017).

The acid number of the sample is the number of milligrams of potassium hydroxide required to neutralize 1 gram of sample as determined by potentiometric titration. The measurement is according to ASTMD-D664 (2018) by potentiometric titration. In details, an appropriate amount of the latex is weighed into a titration vessel and diluted with isopropanol(IPA)-water solvent mixture. The sample is then titrated with KOH until the equivalence point using an automatic titrator such as Mettler DL 50. Volume average particle size was measured by dynamic light scattering using a Nanotrac UPA150 from Microtrac.

The pH was measured with portable or benchtop pH meters from Cole Parmer.

The experimental results are tabulated in Table 1 (Examples 1-9) and Table 2 (Examples 10-17).

TABLE 1
Properties after drying and calendering

| Example | 1 | 2 | 3 | 4 | 5 | 6 | 7 | 8 | 9 |
|---|---|---|---|---|---|---|---|---|---|
| Measured Solids | 30 | 31 | 30 | 30 | 30 | 30 | 30 | 30 | 30 |
| (wt %) (Binder) | | | | | | | | | |
| Estimated | 3 | −7 | 11 | 35 | 17 | 12 | 29 | 45 | 30 |
| Tg (° C.) | | | | | | | | | |
| EA (wt %) | — | — | — | — | 57 | 62 | 51.5 | 54 | 65.2 |
| BA (wt %) | 63.8 | 68.8 | 59.75 | 48.75 | — | — | 10 | — | — |
| MAA (wt %) | 36 | 31 | 40 | 51 | — | — | 38 | 44 | 34.6 |
| AMPS Na | | | | | 1 | 1 | | | |
| AA (wt %) | — | — | — | — | 41.9 | 36.9 | — | — | — |
| Crosslinker | DAP | DAP | DAP | DAP | APE | APE | DAP | DVB | FRA |
| type | | | | | | | | | |
| Crosslinker | 0.2 | 0.2 | 0.25 | 0.25 | 0.1 | 0.1 | 0.5 | 2 | 0.2 |
| amount (wt %) | | | | | | | | | |
| Acid Number | | 202.2 | | | 326.4 | | 247.8 | | |
| Mass loading | — | 11.9 | — | — | 10.7 | — | 8.5 | — | — |
| (mg/cm²) | | | | | | | | | |
| Thickness (μm) | — | 75.9 | — | — | 67.3 | — | 54.3 | — | — |
| Porosity (%) | — | 29.4 | — | — | 28.7 | — | 31.3 | — | — |
| Peel Strength | — | 9.3 | — | — | 11.3 | — | 27.9 | — | — |
| (N/m) | | | | | | | | | |
| Resistivity at | — | 6.1 | — | — | 14.9 | — | 7.2 | — | — |
| 100N (Ω · cm) | | | | | | | | | |
| (electrode) | | | | | | | | | |

DAY: diallyl phthalate; EGDMA: ethylene glycol dimethacrylate; MBA: methylene bis 5 acrylamide; DVB: Divinylbenzene; FRA: bicyclopentenyloxyethyl-methacrylate AYE: trimethylol propane triallyl ether; AA: acrylic acid; BA: butyl acrylate; MAA: methacrylic acid; BA: ethyl acrylate; AMVPS Na: 2-acrylamido-2-methylpropane sulfonic acid sodium salt

TABLE 2
Properties after drying and calendering

| | | | | | | | | | Comparative | |
|---|---|---|---|---|---|---|---|---|---|---|
| | | | | | | | | | 18 | |
| | Example | | | | | | | | Acrysol | 19* |
| | 10 | 11 | 12 | 13 | 14 | 15 | 16 | 17 | ASE-60 | (comp) |
| Measured Solids | 30 | 28 | 32 | 30 | 32 | 31 | 30 | 30 | 28 | |
| (wt %) (Binder) | | | | | | | | | | |
| Estimated | 29 | 18 | 53 | 31 | 38 | 0 | 43 | 38 | 84 | 106 |
| Tg (° C.) | | | | | | | | | | |
| EA (wt %) | 56 | 72 | 54 | 64 | 63 | 61.5 | 59 | 63 | — | |
| BA (wt %) | — | — | — | — | — | — | — | — | — | |
| MAA (wt %) | 41 | 27.5 | 43 | 34 | 37 | — | 40.7 | 37 | — | |
| AMPS Na | | | | | | 1.5 | | | | |
| AA (wt %) | — | — | — | — | — | 37 | — | — | | 100 |
| Crosslinker | EGDMA/ | FRA | EGDMA/ | EGDMA | — | — | DAP | — | — | |
| type | MBA | | MBA | | | | | | | |
| Crosslinker | EGDMA: 1.5 | 0.5 | EGDMA: 1.5 | 2 | 0 | 0 | 0.25 | 0 | — | |
| amount (wt %) | MBA: 1.5 | | MBA: 1.5 | | | | | | | |
| Acid Number | | | 280.5 | | 241.4 | | 265.8 | 241.4 | 274 | 779.2 |
| Mass loading | — | — | 9 | — | 8.1 | — | 9.2 | 8.7 | 7.2 | cracked |
| (mg/cm²) | | | | | | | | | | |
| Thickness (μ) | — | — | 55.7 | — | 52.3 | — | 57.5 | 56.4 | 45.6 | |
| Porosity (%) | — | — | 28.6 | — | 31.6 | — | 29.2 | 31.5 | 24.3 | |
| Peel Strength | — | — | 19.3 | — | 9.4 | — | 12.8 | 12.9 | 4.8 | |
| (N/m) | | | | | | | | | | |
| Resistivity | — | — | 8.2 | — | 10 | — | 11.6 | 10 | | |
| at 100N (Ω · cm) | | | | | | | | | | |
| (electrode) | | | | | | | | | | |

Lower Tg and comonomer including an acid provided an electrode with a low resistivity and good peel strength.

*cracked and did not make a good film.

DAP: diallyl phthalate; EGDMA: ethylene glycol dimethacrylate; MBA: methylene bis acrylamide; DVB: Divinylbenzene; FRA: bicyclopentenyloxyethyl-methacrylate APE: trimethylol propane triallyl ether; AA: acrylic acid; BA: butyl acrylate; MAA: methacrylic acid; EA: ethyl acrylate; AMPS Na: 2-acrylamido-2-methylpropane sulfonic acid sodium salt

Even at higher Tg, the inclusion of the acid-containing monomers in the binders provided a low resistivity electrode with good peel strength.

Comparative examples are from US Pub. 2020/203704 A1 in which ACRYSOL™ ASE-60 was used.

In some embodiments, the invention herein can be construed as excluding any element or process that does not materially affect the basic and novel characteristics of the composition or process. Additionally, in some embodiments, the invention can be construed as excluding any element or process not specified herein.

Although the invention is illustrated and described herein with reference to specific embodiments, the invention is not intended to be limited to the details shown. Rather, various modifications may be made in the details within the scope and range of equivalents of the claims and without departing from the invention.

1. A electrode forming slurry composition comprising;
a) from 10 to 300 parts of one or more particulate anode-forming materials;
b) from 0.1 to 60 parts of polymeric latex particles comprising:
i) at least one ethylenically unsaturated monomer comprising at least one acid functional group; and
ii) no fluorinated monomer or monomer containing conjugated double bonds polymerized therein;
wherein the polymeric latex particles b) have:
a Tg of 55° C. or less and/or a minimum film forming temperature of 25° C. or less;
a volume average particle size of less than 500 nm; and
an acid number of from 40 to 400 mg of KOH equivalent such that at least 10% of the acid functional groups of the at least one ethylenically unsaturated monomer comprising at least one acid functional group are neutralized,
and wherein 5% by weight of the polymeric latex particles b) in water have a viscosity of at least 1000 cP at a shear rate of 10 s-1 and 25° C. at a pH of from 3 to 7;
c) 100 parts water;
d) optionally from 0 to 5 parts of one or more wetting agents;
e) optionally from 0 to 5 parts of one or more dispersing agents;
f) optionally from 0 to 5 parts of one or more VOCs, and/or adhesion promoters and/or coalescent agents;
g) optionally from 0 to 5 parts of rheology modifier additives; and
h) optionally from 0 to 10 parts of one or more additives selected from the group consisting of anti-settling agents, surfactants, and mixtures thereof;
wherein the electrode forming slurry composition is capable of forming an electrode.

2. The electrode forming slurry composition of claim 1, wherein the polymeric latex particles b) comprise, as polymerized monomers:
from 10% to 60% by weight of the total polymerized monomers, of the i) at least one ethylenically unsaturated monomer comprising at least one acid functional group, and
further comprise from 40 to 90%, by weight of the total polymerized monomers, of ii) at least one non-ionic ethylenically unsaturated monomer.

3. The electrode forming slurry composition of claim 1, wherein the i) ethylenically unsaturated monomers comprising at least one acid functional group are selected from the group consisting of (meth) acrylic acid, beta-polycarboxy ethyl acrylate, 4-styrene sulfonic acid, 2-acrylamido-2-methylpropane sulfonic acid, vinyl phosphonic acid, vinyl sulfonic acid, mono-esters of itaconic acid, maleic acid, fumaric acid, and mixtures thereof.

4. The electrode forming slurry composition of claim 1, wherein the ii) at least one non-ionic ethylenically unsaturated monomer is selected from the group consisting of C1 to C12 (meth)acrylates, (meth)acrylamides, (meth)acrylonitriles, vinyl acetate, styrene and derivatives thereof, diisobutylene, vinylpyrrolidone, vinylcaprolactam, and mixtures thereof.

5. The electrode forming slurry composition of claim 1, wherein the polymeric latex particles b) further comprise, as polymerized monomers:
iii) from 0.05% to 5%, by weight of total polymerized monomers, of at least one monomer comprising at least two free radical polymerizable ethylenic unsaturations.

6. The electrode forming slurry composition of claim 1, wherein the at least one monomer comprising at least two free radical polymerizable ethylenic unsaturations iii) is selected from the group consisting of allylic ethers derived from polyols selected from pentaerythritol, sorbitol, or sucrose; diacrylic or dimethacrylic esters derived from polyols selected from pentaerythritol, sorbitol, or sucrose; divinyl naphthalene, trivinylbenzene, 1,2,4-trivinylcyclohexane, triallyl pentaerythritol, diallyl pentaerythritol, diallyl sucrose, trimethylolpropane diallyl ether, 1,6-hexanediol di(meth)acrylate, allyl (meth)acrylate, diallyl itaconate, diallyl fumarate, diallyl maleate, butanediol dimethacrylate, ethylene di(meth)acrylate, poly(ethylene glycol) di(meth)acrylate, trimethylolpropane tri(meth)acrylate, methylenebis(meth)acrylamide, triallylcyanurates, diallyl phthalate, divinylbenzene and mixtures thereof in the polymeric latex particles b) at from 0.05 to 10% by weight of the total polymerized monomers in the polymeric latex particles b).

7. The electrode forming slurry composition of claim 1, wherein the polymeric latex particles b) further comprise, as polymerized monomers:
iv) from 0.1 to 15 to wt % of at least one oxyalkylated monomer with ethylenic unsaturation and terminated by a hydrogen or hydrophobic aryl or alkyl chain with 1 to 60 carbon atoms, having the following formulae-: 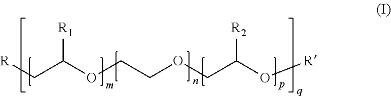
wherein:
m and p represent a number of alkylene oxide units of from 0 and 150,
n represents a number of ethylene oxide units of from 5 and 150,
q represents a whole number at least equal to 1 and such that 5 (m+n+p)q 150, R1 and R2 represent hydrogen, methyl or ethyl,
R represents a group comprising at least one polymerizable olefinic unsaturation, and mixtures thereof, and
R′ represents a hydrogen or hydrophobic aryl or alkyl chain end with 1 to 60 carbon atoms.

8. The electrode forming slurry composition of claim 7, wherein q represents a whole number at least equal to 1 and such that 15≤(m+n+p)q≤120.

9. The electrode forming slurry composition of claim 7, wherein R represents a group selected from the group consisting of acrylate, methacrylate, acrylurethane, methacrylurethane, vinyl, allyl, methallyl, isoprenyl, an unsaturated urethane group, and combinations thereof.

10. The electrode forming slurry composition of claim 7, wherein R represents a group selected from the group consisting of acrylurethane, methacrylurethane, α-α′-dimethyl-isopropenyl-benzylurethane, allylurethane, and combinations thereof.

11. The electrode forming slurry composition of claim 7, wherein R represents a group selected from the group consisting of acrylate, methacrylate, acrylurethane, methacrylurethane, vinyl, allyl, methallyl and isoprenyl, esters of maleic acid, esters of itaconic acid, esters of crotonic acid, and combinations thereof.

12. The electrode forming slurry composition of claim 7, wherein R represents a methacrylate group.

13. The electrode forming slurry composition of claim 1, wherein 5 wt % of the latex particles b) in water have a viscosity of at least 2000 cP at a shear rate of 10 s-1 and 25° C. and a pH of 3 to 7.

14. The electrode forming slurry composition of claim 1, wherein the polymeric latex particles b) are self-thickening such that under a pH equal to or less than 4, an emulsion consisting of 5 wt % of the polymeric latex particles in water have a viscosity of less than 100 cP at a shear rate of 10 s-1 and 25° C., and upon addition of a base such that the pH is from 3 to 7, the viscosity of the emulsion increases to at least 1000 cP at shear rate of 10 s-1 and 25° C.

15. The electrode forming slurry composition of claim 1, wherein the pH of the slurry composition is less than 7.

16. The electrode forming slurry composition of claim 1, further comprising lithium hydroxide.

17. The electrode forming slurry composition of claim 1, wherein the polymeric latex particles b) have a volume average particle size less than 250 nanometers.

18. The electrode forming slurry composition of claim 1, wherein the composition is free of carboxymethyl cellulose (CMC).

19. The electrode forming slurry composition of claim 1, wherein the composition is free of polymers comprising, as polymerized monomers, monomers comprising conjugated double bonds.

20. The electrode forming slurry composition of claim 1 wherein a VOC content of the composition is from 0 to less than 1 wt %.

21. The electrode forming slurry composition of claim 1, wherein the polymeric latex particles b) have a Tg of 25° C. or less.

22. The electrode forming slurry composition of claim 1, wherein the particulate anode-forming materials a) comprise one or more materials selected from the group consisting of furnace black, acetylene black, Ketjen carbon black, carbon nanotubes (CNTs), synthetic graphite, natural graphite, hard carbon, activated soft carbon, carbon black, graphene, mesoporous carbon, amorphous silicon, semi-crystalline silicon, silicon oxides, silicon nanowires, tin, tin oxides, germanium, lithium titanate, and mixtures or composites thereof.

23. An anode for use within an electrical energy storage device comprising a current collector coated on at least one surface with the electrode forming slurry composition of claim 1 in dried form, wherein the anode has a thickness of at least 10 microns and exhibits resistivity less than 100 Ω·cm in the z-direction.

24. An electrical energy storage device containing a non-aqueous electrolyte, the electrical energy storage device comprising at least one anode of claim 21, wherein the electrical energy storage device is selected from the group consisting of a non-aqueous-type battery, a capacitor, and a membrane electrode assembly.
